(19) United States
(12) Patent Application Publication
(10) Pub. No.: US 2011/0105113 A1
(43) Pub. Date: May 5, 2011

(54) RADIO COMMUNICATION DEVICE AND RADIO COMMUNICATION METHOD

(75) Inventor: Shingo Joko, Kanagawa (JP)

(73) Assignee: KYOCERA CORPORATION, Kyoto-shi, Kyoto (JP)

(21) Appl. No.: 12/995,104

(22) PCT Filed: May 29, 2009
(86) PCT No.: PCT/JP2009/059856

§ 371 Date: Jan. 19, 2011

(30) Foreign Application Priority Data
May 29, 2008 (JP) 2008-141755

(51) Int. Cl. H04W 24/00; H04W 72/10

(52) U.S. Cl. 455/424; 455/425

(57) ABSTRACT

A radio base station (1) transmits initial transmission data to a radio terminal and receives from the radio terminal, a response message indicating whether the radio terminal has successfully decoded the initial transmission data. The radio base station (1) includes a controller (112) which judges whether the response message has been normally received. If NO, a part of the initial transmission data is transmitted as retransmission data to the radio terminal.

### TECHNICAL FIELD

The present invention relates to a radio communication device and radio communication method to which hybrid automatic repeat request is applied.

### BACKGROUND ART

Generally, transmission errors occur more frequently in a radio communication system than in a wireline communication system. To ensure reliability in communication in such a radio communication system, hybrid automatic repeat request (HARQ) in which both of automatic repeat request (ARQ) and forward error correction (FEC) are used together has been widely employed in recent years.

In HARQ, upon success in decoding data transmitted by a transmission-side radio communication device (called transmission device below), a reception-side radio communication device (called reception device below) transmits a positive response (called Ack below) indicating success of the decoding to the transmission device. Upon failure in decoding the data, the reception device transmits a negative response (called Nack below) indicating failure of the decoding to the transmission device (see Patent Document 1, for example).

Upon receipt of a retransmission request, the transmission device transmits initially-transmitted data (called transmission data below) as retransmission data to the reception device. The reception device stores the transmission data for which decoding had failed, and upon receipt of the retransmission data from the transmission device, performs decoding by combining the stored transmission data with the received retransmission data. In HARQ, error correction capability is improved by such processing. Hereinafter, Ack and Nack are collectively referred to as “response message” as appropriate.

Patent Document 1: Japanese Patent Application Publication No. 2003-179581 (see [Claim 1] and the like)

### DISCLOSURE OF THE INVENTION

As described above, in HARQ, retransmission is controlled according to a response message from the reception device. However, the transmission device cannot always normally receive a response message from the reception device. If the transmission device fails in receiving the response message, the state of the reception device is unknown to the transmission device.

In this case, the conventional transmission device continues communication according to one of the following methods (a) or (b). (a) The transmission device regards that the reception device has failed in decoding the transmission data, and transmits the entire already-transmitted transmission data as retransmission data to the reception device. (b) The transmission device requests the reception device to retransmit the response message.

However, the method (a) has a problem that a large amount of radio resource is consumed wastefully by the retransmission, because retransmission of the retransmission data is unnecessary if the reception device actually has succeeded in decoding the transmission data. In particular, in a case where the transmission device is a radio base station which communicates with multiple reception devices, an increase in an amount of the radio resource allocated to a certain reception device (radio terminal) relatively decreases an amount of the radio resource allocatable to other reception devices.

Meanwhile, in the method (b), if the reception device actually has failed in decoding the transmission data, the transmission device transmits a response-message retransmission request to the reception device, receives a response message from the reception device and then transmits the retransmission data. That is, the above method (b) has a problem that a large retransmission delay occurs.

Hence, the present invention has been made to solve the above problems, and has an objective to provide a radio communication device and radio communication method which allow communication with a reception device to be maintained while reducing consumption of a radio resource and suppressing retransmission delay, when a response message from the reception device has not been normally received in a radio communication system to which HARQ is applied.

In order to solve the above problem, the present invention has the following aspects. A first aspect of the present invention is a radio communication device (radio base station 1) comprising : a data transmitter (transmission and reception unit 111) configured to transmit encoded transmission data to a reception device (radio terminal 2); a response receiver (transmission and reception unit 111) configured to receive from the reception device a response message indicating whether or not the reception device has succeeded in decoding the transmission data; and a retransmission processor (controller 112) configured to transmit to the reception device retransmission data corresponding to the transmission data transmitted by the data transmitter when the response message received by the response receiver indicates failure of the decoding of the transmission data, the retransmission data being combined with the transmission data in the reception device, the radio communication device comprising a response judgment unit (controller 112) configured to judge whether or not the response receiver has normally received the response message after the transmission of the transmission data, wherein the retransmission processor transmits a part of the transmission data as the retransmission data to the reception device if the response judgment unit judges that the response receiver has not normally received the response message.

According to this radio communication device, if it is judged that the response message has not been normally received from the reception device, the retransmission processor transmits the part of the transmission data as the retransmission data to the reception device.

Accordingly, consumption of a radio resource can be reduced as compared to the conventional method in which the entire transmission data is transmitted to the reception device as the retransmission data. In addition, retransmission delay can be suppressed as compared to the conventional method in which the reception device is requested to retransmit the response message. Note that the reception device can decode the retransmission data even though only a part of the transmission data is transmitted as retransmission data. This is because the retransmission data is combined with the transmission data in the reception device.

Hence, according to the first aspect of the radio communication device, communication with the reception device can be maintained while reducing consumption of a radio resource and suppressing retransmission delay, when the response message from the reception device has not been normally received in a radio communication system to which HARQ is applied.

A second aspect of the present invention is the first aspect of the present invention further comprising an information receiver (transmission and reception unit 111) configured to receive from the reception device receiving quality information (CQI) indicating receiving quality (for example received SNR) of a radio signal transmitted by the radio communication device; an error rate estimation unit (data size determination unit 115) configured to estimate an error rate of the transmission data received by the reception device, the error rate being estimated according to the receiving quality information received by the information receiver; and a size determination unit (data size determination unit 115) configured to determine a size of the retransmission data to be transmitted by the retransmission processor in a case where the retransmission processor transmits the part of the transmission data as the retransmission data, the size being determined according to the error rate estimated by the error rate estimation unit.

A third aspect of the present invention is the second aspect of the present invention further comprising the radio communication device, wherein the size determination unit increases the size of the retransmission data as the error rate becomes higher, and reduces the size of the retransmission data as the error rate becomes lower.

A fourth aspect of the present invention is the second aspect of the present invention further comprising a resource allocation unit (controller 112) configured to allocate a radio resource to be used for data transmission to any of the reception device (radio terminal 3) and another reception device different from the reception device, wherein the retransmission processor transmits the part of the transmission data as retransmission data by use of the radio resource, and the resource allocation unit allocates the radio resource to both of the reception device and the different reception device in a case where the retransmission processor transmits the part of the transmission data as the retransmission data.

A fifth aspect of the present invention is the fourth aspect of the present invention further comprising the radio communication device, wherein the size determination unit determines a difference between a size of the transmission data and the determined size of the retransmission data as a size of certain data to be transmitted to the different reception device.

A sixth aspect of the present invention is the fourth aspect of the present invention further comprising a priority setting unit (scheduler 114) configured to, in a case where there are a plurality of the different reception devices, set for each of the plurality of reception devices a priority with which the resource allocation unit allocates the radio resource, the priority set according to the receiving quality information received by the information receiver, wherein the resource allocation unit allocates the radio resource to a reception device having the highest priority among the plurality of reception devices and to the reception device to which the retransmission data is transmitted, in a case where the retransmission processor transmits the part of the transmission data as the retransmission data.

A seventh aspect of the present invention is the fifth aspect of the present invention further comprising a modulation scheme determination unit (controller 112) configured to determine a first modulation scheme used for data transmission to the reception device and a second modulation scheme used for data transmission to the different reception device; and a size adjustment unit (scheduler 114) configured to adjust the size of each of the retransmission data and the certain data determined by the size determination unit, the adjustment being made according to the first modulation scheme and the second modulation scheme determined by the modulation scheme determination unit.

A eigth aspect of the present invention is the seventh aspect of the present invention further comprising the radio communication device, wherein the size adjustment unit reduces the size of the retransmission data and increases the size of the certain data if an amount of information per symbol defined in the first modulation scheme is smaller than an amount of information per symbol defined in the second modulation scheme; and the size adjustment unit increases the size of the retransmission data and reduces the size of the certain data if the amount of information per symbol defined in the first modulation scheme is larger than the amount of information per symbol defined in the second modulation scheme.

A ninth aspect of the present invention is the first aspect of the present invention further comprising a modulation scheme determination unit (controller 112) configured to determine a modulation scheme to be used for data transmission to the reception device; and a size determination unit (data size determination unit 115) configured to determine a size of the retransmission data to be transmitted by the retransmission processor in a case where the retransmission processor transmits the part of the transmission data as the retransmission data, the size being determined according to the modulation scheme determined by the modulation scheme determination unit.

A tenth aspect of the present invention is the first aspect of the present invention further comprising the radio communication device, wherein in a case where the response judgment unit judges that the response message has not been received normally and where the transmission data is real-time data for which low latency is required, the retransmission processor transmits the entire transmission data as the retransmission data; and in a case where the response judgment unit judges that the response message has not been received normally and where the transmission data is data other than the real-time data, the retransmission processor transmits the part of the transmission data as the retransmission data.

A eleventh aspect of the present invention is a radio communication method including the steps of transmitting encoded transmission data to a reception device receiving from the reception device a response message indicating whether or not the reception device has succeeded in decoding the transmission data; and transmitting to the reception device retransmission data corresponding to the transmission data when the response message received in the receiving step indicates failure of the decoding of the transmission data, the retransmission data being combined with the transmission data in the reception device, the radio communication method comprising a step of judging whether or not the response message has been normally received from the reception device after the transmission of the transmission data, wherein in the step of transmitting the retransmission data, a part of the transmission data is transmitted as the retransmission data if it is judged that the response message has not been normally received in the judging step.

According to the present invention, provided is a radio communication device and radio communication method, which allow communication with a reception device to be maintained while reducing consumption of a radio resource and suppressing retransmission delay, when a response message from the reception device has not been normally received in a radio communication system to which HARQ is applied.

### BRIEF DESCRIPTION OF THE DRAWINGS

FIG. 1 is an overall schematic configuration diagram of a radio communication system according to an embodiment of the present invention.

FIG. 2 is a functional block configuration diagram of a radio base station according to the embodiment of the present invention.

FIG. 3 is a conceptual diagram for explaining retransmission size determination processing performed by a data size determination unit according to the embodiment of the present invention.

FIG. 4 is a diagram showing a configuration example of a table according to the embodiment of the present invention, in which CQIs and received SNRs are associated with each other.

FIG. 5 is a diagram showing a configuration example of a table according to the embodiment of the present invention in which modulation schemes, received SNRs and error rates are associated with each other.

FIG. 6 is a diagram for explaining modulation schemes used in adaptive modulation.

FIG. 7 is a flowchart showing an operation of the radio base station according to the embodiment of the present invention.

### BEST MODE FOR CARRYING OUT THE INVENTION

Next, a description will be given of a radio communication system according to an embodiment of the present invention with reference to the drawings. Specifically, descriptions will be given of (1) an overall schematic configuration of the radio communication system, (2) a configuration of a radio base station, (3) an example of retransmission size determination processing, (4) an example of error rate estimation processing, (5) an example of size adjustment processing, (6) an operation of the radio base station, (7) advantageous effects, and (8) other embodiments. In the following description of the drawings of the embodiment, same or similar reference signs denote same or similar portions.

(1) Overall Schematic Configuration of Radio Communication System

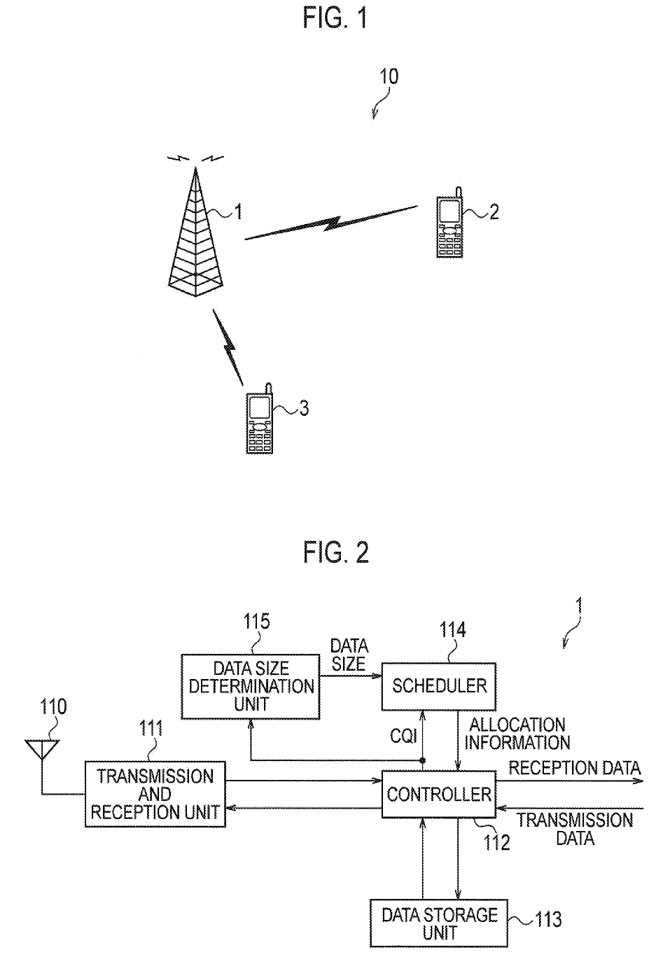

FIG. 1 is an overall schematic configuration diagram of a radio communication system 10 according to this embodiment. As shown in FIG. 1, the radio communication system 10 includes a radio base station 1, a radio terminal 2 and a radio terminal 3.

The radio terminal 2 and radio terminal 3 are positioned within a service area of the radio base station 1, and communicate with the radio base station 1 via radio intervals. Although only a total of two radio terminals which are the radio terminal 2 and radio terminal 3 are shown in the example in FIG. 1, multiple radio terminals may communicate with the radio base station 1.

In this embodiment, the radio terminal 2 and radio terminal 3 constitute multiple reception devices which receive data from the radio base station 1. The radio base station 1 constitutes a radio communication device which performs radio communication with the multiple reception devices.

The radio terminal 2 and radio terminal 3 periodically measure receiving quality of a radio signal transmitted from the radio base station 1, that is specifically, of a pilot signal being a broadcast signal, and periodically transmit receiving quality information indicating the receiving qualities thereof to the radio base station 1. In this embodiment, the receiving quality measured by the radio terminal 2 and radio terminal 3 is a received SNR (Signal to Interference plus Noise power Ratio). Hereinafter, the receiving quality information transmitted from the radio terminal 2 and radio terminal 3 to the radio base station 1 is referred to as CQI (Channel Quality Indicator).

The radio communication system 10 employs the aforementioned HARQ. In this embodiment, the radio terminal 2 fails to decode initial transmission data received from the radio base station 1, and transmits a Nack, which is a negative response message for requesting retransmission of the initial transmission data, to the radio base station 1. Specifically, the radio terminal 2 is a transmission destination of the retransmission data for which retransmission is requested, and the radio terminal 3 is a transmission destination of transmission data for which retransmission is not requested (initial transmission data) or of the retransmission data for which retransmission is requested.

Note that in general HARQ, the reception side transmits to the transmission side a positive response message (Ack) indicating success of decoding when data (data packet) transmitted from the transmission side is successfully decoded, or a negative response message (Nack) indicating failure of the decoding when the decoding fails. In the following embodiment, Ack and Nack are collectively referred to as “response message.”

In the radio communication system 10, transmission errors and data losses are likely to occur in a radio interval, and the transmission side is sometimes unable to normally receive a response message from the reception side. Here, a state of being unable to normally receive a response message refers to a state where a response message is not received, a state where a response message is received but cannot be decoded, or a state where a response message is decoded but an error is included in the decoding result.

The radio base station 1 allocates a radio resource to each of the radio terminal 2 and radio terminal 3 on the basis of a CQI received from each of the radio terminal 2 and radio terminal 3, and transmits data to the radio terminal 2 or radio terminal 3 by use of the allocated radio resource. Here, the radio resource to be used for data transmission refers to a transmission time frame (called transmission slot below), a frequency channel or the like. In the following embodiment, for simplifying the description, a transmission slot is cited as an example of the radio resource allocated by the radio base station 1 in the description.

In addition, the radio communication system 10 employs the adaptive modulation scheme for improvement of the communication rate. The radio base station 1 dynamically switches the modulation scheme (called “modulation class” below as appropriate) according to a CQI received from each of the radio terminal 2 and the radio terminal 3. To be specific, the radio base station 1 selects an appropriate modulation scheme from among multiple modulation schemes such as BPSK (Binary Phase Shift Keying) and 24 QAM (Quadrature Amplitude Modulation).

In HARQ, retransmission gain can be obtained by combining initial transmission data and retransmission data. Hence, performance of the system as a whole can be enhanced by selecting a high modulation class in expectation of the retransmission gain, instead of selecting a low modulation class to complete transmission of the whole data in one transmission.

For this reason, retransmission is frequently performed in this type of system.

(2) Configuration of Radio Base Station

Next, a configuration of the radio base station 1 will be described. FIG. 2 is a functional block configuration diagram of the radio base station 1.

As shown in FIG. 2, the radio base station 1 includes an antenna 110, a transmission and reception unit 111, a controller 112, a data storage unit 113, a scheduler 114 and a data size determination unit 115.

The transmission and reception unit 111 transmits and receives radio signals including data, via the antenna 110. The transmission and reception unit 111 transmits encoded (error correction coded) initial transmission data to the radio terminal 2. The transmission and reception unit 111 receives the aforementioned response message from the radio terminal 2. Further, the transmission and reception unit 111 receives a CQI indicating a received SNR of the radio signal transmitted from the radio base station 1, from each of the radio terminals 2 and 3.

In other words, in this embodiment, the transmission and reception unit 111 constitutes a data transmitter which transmits initial transmission data, a response receiver which receives a response message and an information receiver which receives receiving quality information (CQI).

The data storage unit 113 temporarily stores transmission data to be transmitted to the radio terminal 2, as well as stores already-transmitted initial transmission data until the transmission and reception unit 111 receives an Ack. When the transmission and reception unit 111 receives a Nack, the initial transmission data stored in the data storage unit 113 is acquired by the controller 112 and retransmitted as retransmission data.

The controller 112 controls the overall operation of the radio base station 1. To be specific, the controller 112 controls transmission, retransmission and the like of data (data packet) to the radio terminal 2. When the transmission and reception unit 111 receives a Nack, the controller 112 transmits retransmission data corresponding to the initial transmission data transmitted by the transmission and reception unit 111 to the radio terminal 2.

Further, after transmitting the initial transmission data, the controller 112 judges whether or not the transmission and reception unit 111 has normally received a response message. Judging that the transmission and reception unit 111 has not normally received a response message, the controller 112 transmits a part of the initial transmission data stored in the data storage unit 113 as retransmission data to the radio terminal 2.

In other words, in this embodiment, the controller 112 constitutes a response judging unit which judges whether or not a response message has been normally received, and a retransmission processor which transmits a part of the initial transmission data as retransmission data to the radio terminal 2.

Note that the controller 112 also functions as a modulation scheme determination unit which determines a modulation scheme used for data transmission to the radio terminal 2 and a modulation scheme used for data transmission to the radio terminal 3, the determination being made according to a CQI received by the transmission and reception unit 111.

The data size determination unit 115 estimates an error rate (packet error rate) of the initial transmission data received by the radio terminal 2, in accordance with a CQI received by the transmission and reception unit 111, that is specifically, a CQI corresponding to the time of transmission of the initial transmission data. In addition, the data size determination unit 115 determines the size of retransmission data in accordance with the estimated error rate.

In this embodiment, the data size determination unit 115 constitutes an error rate estimation unit which estimates an error rate of the initial transmission data received by the radio terminal 2, and a size determination unit which determines the size of retransmission data.

In a case of transmitting a part of the initial transmission data as retransmission data, the data size determination unit 115 determines a difference between the size of the initial transmission data and the determined size of the retransmission data as the size of data to be transmitted to the radio terminal 3. Here, the data to be transmitted to the radio terminal 3 is initial transmission data or retransmission data. Hereinafter, the initial transmission data or retransmission data to be transmitted to the radio terminal 3 is referred to as “certain data” as appropriate.

According to the above CQI, the scheduler 114 sets for each radio terminal a priority with which the controller 112 allocates a radio resource. In other word, in the radio communication system 10, the scheduler 114 is used so that the radio base station 1 may manage the multiple radio terminals and effectively utilize a radio resource.

Schemes for the scheduler 114 include the Max CIR scheme and PF (Proportional Fair) scheme. In the Max CIR scheme, a high priority is set for a radio terminal having a high instantaneous received SNR (called instantaneous received SNR below). On the other hand, in the PF scheme, a high priority is set for a radio terminal whose instantaneous received SNR is relatively higher than an average received SNR. Specifically, in the PF scheme, the scheduler 114 computes a priority by solving priority=DRC/R. Here, DRC represents an instantaneous data rate computed from a CQI, and R represents a value obtained by averaging data rates by an exponentially weighted average or the like using a certain time constant. Accordingly, a ratio of an instantaneous data rate (instantaneous received SNR) to an average rate (average received SNR) is computed as the priority.

The controller 112 allocates a radio resource to the radio terminal 2 or radio terminal 3 according to the priorities set by the scheduler 114, the radio resource being that to be used for data transmission. In other words, the controller 112 constitutes a resource allocation unit which allocates a radio resource. In a case of transmitting a part of initial transmission data as retransmission data to the radio terminal 2, the controller 112 allocates a radio resource to both of the radio terminal 2 and radio terminal 3.

(3) Example of Retransmission Size Determination Processing

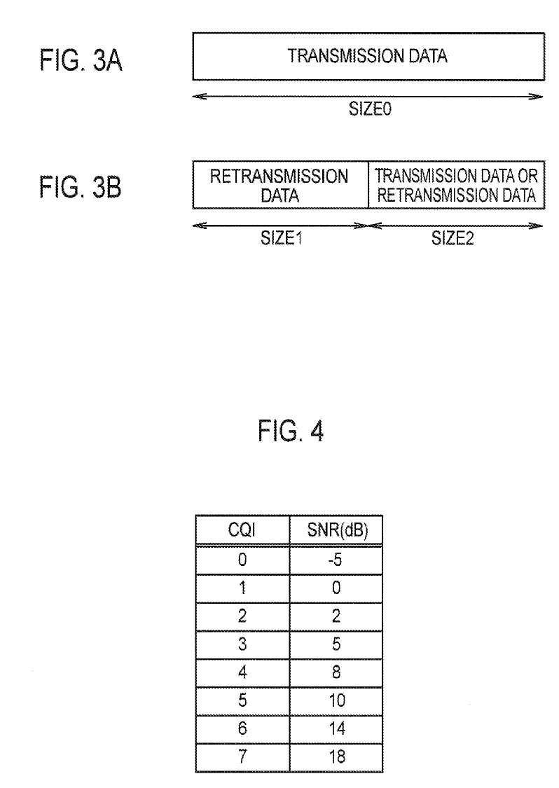

As described above, judging that a response message has not been normally received from the radio terminal 2, the controller 112 of the radio base station 1 transmits a part of initial transmission data as shown in FIG. 3(a) as retransmission data as shown in FIG. 3(b) to the radio terminal 2. A size SIZE1 of the retransmission data shown in FIG. 3(b) is determined as follows.

Judging that a response message has not been normally received from the radio terminal 2, the controller 112 notifies the data size determination unit 115 of a CQI of the radio terminal 2 at the time of transmission of the initial transmission data shown in FIG. 3(a). According to the CQI thus notified, the data size determination unit 115 estimates an error rate R of the initial transmission data received by the radio terminal 2, and determines the size SIZE1 of the retransmission data according to the error rate R.

For example, the data size determination unit 115 determines the result of multiplying a size SIZE0 of the initial transmission data shown in FIG. 3(a) by the estimated error rate R as the size SIZE1 of the retransmission data as shown in the following equation (1).

SIZE1=SIZE0×R (1)

Specifically, in a case where it is uncertain whether or not the radio terminal 2 has successfully decoded initial transmission data, most parts of the initial transmission data is retransmitted if it is more likely that the decoding has failed, and only a small part of the initial transmission data is retransmitted if it is less likely that the decoding has failed. Note that even if the response message is not received normally, the size SIZE1 of the retransmission data becomes equal to the size SIZE0 of the initial transmission data only when the estimated error rate R is 100%.

As shown in FIG. 3(b), the data size determination unit 115 determines the difference (SIZE0−SIZE1) between the size SIZE0 of the initial transmission data and the size SIZE1 of the retransmission data as the size SIZE2 of the initial transmission data or retransmission data to be transmitted to the radio terminal 3.

Note, however, that in a case where there are multiple radio terminals (that is, the radio terminals 3) other than the radio terminal 2, a radio resource is allocated to the radio terminal 3 for which the scheduler 114 sets the highest priority among the multiple radio terminals 3.

Specifically, the following relationship holds among the size SIZE0 of the initial transmission data, the size SIZE1 of the retransmission data and the size SIZE2 of the certain data to be transmitted to the radio terminal 3.

SIZE2=SIZE0−SIZE1 (2)

Thus, the total of the size SIZE1 of the retransmission data and the size SIZE2 of the certain data to be transmitted to the radio terminal 3 is equal to the size SIZE0 of the initial transmission data. In other words, the retransmission data to the radio terminal 2 and the certain data to the radio terminal 3 are transmitted by pieces of a radio resource (transmission slots) whose total size is the same as the radio resource (transmission slot) by which the initial transmission data was transmitted.

The data size determination unit 115 notifies the scheduler 114 of the size SIZE1 and the size SIZE2 determined by use of the equation (1) and equation (2). The scheduler 114 adjusts the sizes SIZE1 and SIZE2 according to a modulation scheme.

(4) Example of Error Rate Estimation Processing

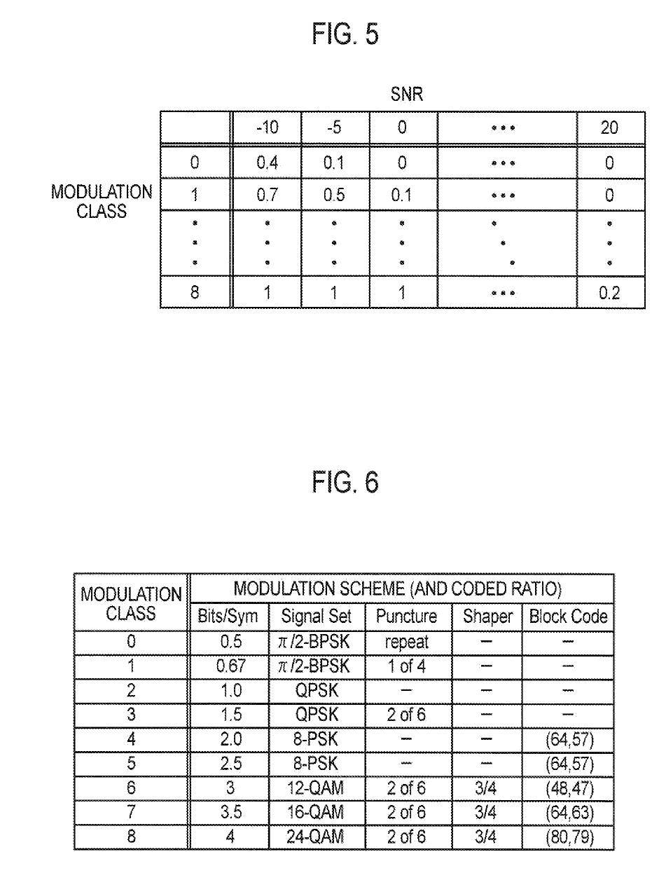

Next, with reference to FIG. 4 and FIG. 5, a description will be given of estimation processing for an error rate R, performed by the data size determination unit 115.

In this embodiment, the data size determination unit 115 estimates an error rate R of the initial transmission data received by the radio terminal 2, according to a CQI of the radio terminal 2 at the time of transmission of the initial transmission data and a modulation scheme (modulation class) at the time of the transmission of the initial transmission data to the radio terminal 2.

The data size determination unit 115 specifies a received SNR of the radio terminal 2 at the time of transmission of the initial transmission data by use of a table in which CQIs and received SNRs are associated with each other as shown in FIG. 4. Further, the data size determination unit 115 specifies an error rate R by use of a table shown in FIG. 5 in which modulation schemes at the time of transmission of the initial transmission data, received SNRs and error rates R are associated with each other.

As shown in FIG. 5, the higher the modulation class, that is, the higher rate the modulation class is, the higher the error rate R becomes. In addition, the higher the received SNR, the lower the error rate R becomes. Note that the values of error rates R shown in FIG. 4 can be obtained in advance by computer simulation.

(5) Example of Size Adjustment Processing

The scheduler 114 adjusts each of the sizes SIZE1 and SIZE2 determined by the data size determination unit 115, the adjustment being made according to a modulation class used for data transmission to the radio terminal 2 and a modulation class used for data transmission to the radio terminal 3.

In the example in FIG. 6, a total of nine modulation classes of modulation classes 0 to 8 are prepared. The modulation class 8 is the highest-rate modulation class, and the modulation class 0 is the lowest-rate modulation class. To be specific, the modulation class 8 employs 24QAM, whereas the modulation class 0 employs π/2-BPSK. In other words, the amount of information per symbol differs among the modulation classes.

The scheduler 114 reduces the size SIZE1 and increases the size SIZE2 if the amount of information per symbol defined in the modulation class used for data transmission to the radio terminal 2 is smaller than the amount of information per symbol defined in the modulation class used for data transmission to the radio terminal 3.

Moreover, the scheduler 114 increases the size SIZE1 and reduces the size SIZE2 if the amount of information per symbol defined in the modulation class used for data transmission to the radio terminal 2 is larger than the amount of information per symbol defined in the modulation class used for data transmission to the radio terminal 3.

Note that the total of the size SIZE1 and size SIZE2 does not vary before and after the size adjustment.

For example, assuming that the modulation class used for data transmission to the radio terminal 2 is α bits per symbol, the modulation class used for data transmission to the radio terminal 3 is β bits per symbol, and the estimated error rate R is 30%, the size of the retransmission data to be transmitted to the radio terminal 2 is (30×(α/(α+β))+(100−30)×(β/(α+β))) % of the initial transmission packet size.

(6) Operation of Radio Base Station

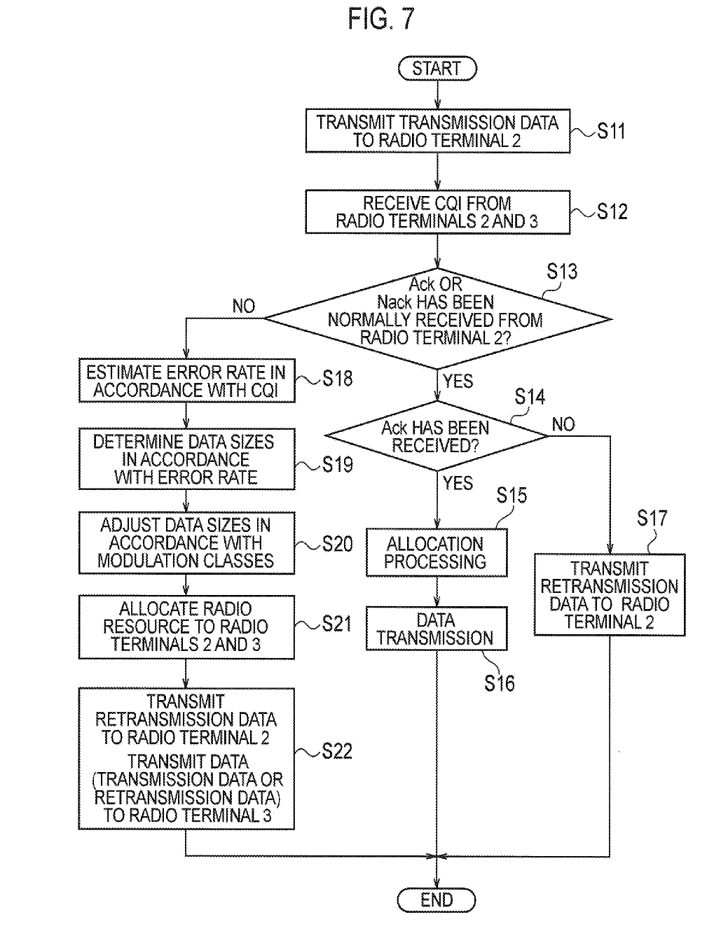

Next, an operation of the radio base station 1 will be described. FIG. 7 is a flowchart showing the operation of the radio base station 1.

In step S11, the transmission and reception unit 111 and the controller 112 transmit initial transmission data to the radio terminal 2. In addition, the transmission and reception unit 111 receives a CQI from each of the radio terminals 2 and 3 (step S12).

The radio terminal 2 performs decoding after receiving initial transmission data from the radio base station 1, carries out a CRC check, and transmits an Ack as a response message to the radio base station 1 if the data is successfully decoded and transmits a Nack as a response message to the radio base station 1 if the data is not successfully decoded.

In step S13, the controller 112 judges whether or not a response message has been normally received from the radio terminal 2. If the response message has been normally received, the processing proceeds to step S14, and if the response message has not been normally received, the processing proceeds to step S18.

In step S14, the controller 112 judges whether the received response message is an Ack or Nack. If the response message is an Ack, the processing proceeds to step S15, and if the response message is a Nack, the processing proceeds to step S17.

In step S15 and step S16, the scheduler 114 and the controller 112 normally performs allocation processing and transmission processing for the next data.

In step S17 being the case where the response message is a Nack, the controller 112 transmits the entire initial transmission data as retransmission data to the radio terminal 2. Upon receipt of the retransmission data, the radio terminal soft-combines the received retransmission data and the initial transmission data, carries out a CRC check and transmits an Ack or a Nack to the radio base station 1, according to the result of the CRC check.

On the other hand, if the response message has not been normally received, in step S18, the data size determination unit 115 estimates an error rate R of the initial transmission data received by the radio terminal 2, in accordance with the CQI received from the radio terminal 2 in step S12.

In step S19, the data size determination unit 115 determines the size SIZE1 of the retransmission data to the radio terminal 2 and the size SIZE2 of the certain data to the radio terminal 3, in accordance with the aforementioned equation (1) and equation (2).

In step S20, the scheduler 114 adjusts each of the sizes SIZE1 and SIZE2 determined by the size determination unit 115, in accordance with the modulation class used for data transmission to the radio terminal 2 and the modulation class used for data transmission to the radio terminal 3.

In step S21, the controller 112 allocates a radio resource to the radio terminal 2 or radio terminal 3, the radio resource being that used for data transmission. Then, in step S23, the transmission and reception unit 111 and the controller 112 transmit the retransmission data to the radio terminal 2 as well as transmit the certain data to the radio terminal 3.

(7) Advantageous Effects

As has been described, after transmitting initial transmission data to the radio terminal 2, the controller 112 judges whether or not a response message has been normally received, and when judging that a response message has not been normally received, transmits apart of the initial transmission data as retransmission data to the radio terminal 2.

As a result, consumption of a radio resource can be reduced as compared to the conventional method in which the entire initial transmission data is transmitted as retransmission data. In addition, retransmission delay can be suppressed as compared to the conventional method in which the radio terminal 2 is requested to retransmit the response message. Note that the radio terminal 2 can decode the retransmission data even if only a part of the initial transmission data is transmitted as retransmission data. This is because the retransmission data is combined (soft combined) with the transmission data in the radio terminal 2.

In this embodiment, the data size determination unit 115 estimates an error rate R of the initial transmission data received by the radio terminal 2, and determines the size of the retransmission data according to the estimated error rate R. To be specific, the data size determination unit 115 makes a determination so that the higher the error rate R, the larger the size of the retransmission data is made, and the lower the error rate R, the smaller the size of the retransmission data is made.

Specifically, in a case where it is uncertain whether or not the radio terminal 2 has successfully decoded initial transmission data, most parts of the initial transmission data is retransmitted if it is more likely that the decoding has failed, and only a small part of the initial transmission data is retransmitted if it is less likely that the decoding has failed. Accordingly, when transmitting a part of the initial transmission data as retransmission data, transmission of only the minimum amount of retransmission data is required while keeping the probability that the radio terminal 2 succeeds in decoding. Thus, a radio resource can be conserved.

In this embodiment, the data size determination unit 115 determines the difference between the size of the initial transmission data and the determined size of the retransmission data as the size of the certain data to be transmitted to the radio terminal 3. Then, when transmitting apart of the initial transmission data as retransmission data to the radio terminal 2, the controller 112 allocates a radio resource to both of the radio terminal 2 and radio terminal 3. Thus, the radio resource corresponding to the reduced amount of retransmission data can be used by another radio terminal, and a radio resource can be utilized efficiently.

Here, if there are multiple radio terminals 3, the controller 112 allocates a radio resource to the radio terminal 2 and to the radio terminal 3 having the highest priority set by the scheduler 114. As described above, the scheduler 114 sets a high priority to a radio terminal having a high SNR, so that data may be transmitted to the radio terminal having the high SNR at an early stage, whereby a radio resource can be utilized efficiently and throughput can be improved.

In this embodiment, the scheduler 114 adjusts the size determined by the data size determination unit 115, in accordance with the modulation scheme. For this reason, in a case where a high-speed modulation scheme is employed, data is transmitted as much as possible so as to efficiently utilize a radio resource and improve throughput.

(8) Other Embodiments

Although the present invention has been described through the embodiment as described above, it should not be construed that the descriptions and drawings constituting a part of this disclosure will limit the present invention. Various alternative embodiments, examples, and operation techniques will be apparent to those skilled in the art from this disclosure.

In the above embodiment, the scheduler 114 adjusts the size determined by the data size determination unit 115, in accordance with the modulation scheme. However, the scheduler 114 may determine the data size in accordance only with the modulation class.

In the above embodiment, a QoS of the initial transmission data (and retransmission data) to be transmitted to the radio terminal 2 is not considered. However, a configuration considering a QoS may be employed.

For example, even if a response message is not received normally, the controller 112 may transmit the entire transmission data as retransmission data in a case where the initial transmission data to be transmitted to the radio terminal 2 is real-time data (such as voice data) which requires low latency.

Although a received SNR is used as the receiving quality in the above embodiment, the invention is not limited to this, and an RSSI (Received Signal Strength Indicator), a received BER (Bit Error Rate) or the like may be used.

Note that although a portable radio terminal is shown in FIG. 1, a fixed radio terminal or a card-type radio terminal may be used instead. Otherwise, a device that does not have a data transmission function may be used instead of the radio terminal.

As described above, it should be understood that the present invention includes various embodiments or the like which have not been described herein. Therefore, the present invention is limited only by specific features of the invention in the claims which are reasonable from the disclosure.

Note that the entire content of Japanese Patent Application No. 2008-141755 (filed on May 29, 2008) is incorporated herein by reference.

### INDUSTRIAL APPLICABILITY

As has been described, the radio communication device and radio communication method according to the present invention have the following effects and are thus advantageous for use in radio communication such as mobile communication. Specifically, provided is a radio communication device and radio communication method, which allow communication with a reception device to be maintained while reducing consumption of a radio resource and suppressing retransmission delay, when a response message from the reception device has not been normally received in a radio communication system to which HARQ is applied.

1. A radio communication device comprising:
a data transmitter configured to transmit encoded transmission data to a reception device;
a response receiver configured to receive from the reception device a response message indicating whether or not the reception device has succeeded in decoding the transmission data; and
a retransmission processor configured to transmit to the reception device retransmission data corresponding to the transmission data transmitted by the data transmitter when the response message received by the response receiver indicates failure of the decoding of the transmission data, the retransmission data being combined with the transmission data in the reception device, the radio communication device comprising
a response judgment unit configured to judge whether or not the response receiver has normally received the response message after the transmission of the transmission data, wherein
the retransmission processor transmits a part of the transmission data as the retransmission data to the reception device if the response judgment unit judges that the response receiver has not normally received the response message.

2. The radio communication device according to claim 1, further comprising:
an information receiver configured to receive from the reception device receiving quality information indicating receiving quality of a radio signal transmitted by the radio communication device;
an error rate estimation unit configured to estimate an error rate of the transmission data received by the reception device, the error rate being estimated according to the receiving quality information received by the information receiver; and
a size determination unit configured to determine a size of the retransmission data to be transmitted by the retransmission processor in a case where the retransmission processor transmits the part of the transmission data as the retransmission data, the size being determined according to the error rate estimated by the error rate estimation unit.

3. The radio communication device according to claim 2, wherein the size determination unit increases the size of the retransmission data as the error rate becomes higher, and reduces the size of the retransmission data as the error rate becomes lower.

4. The radio communication device according to claim 2, further comprising a resource allocation unit configured to allocate a radio resource to be used for data transmission to any of the reception device and another reception device different from the reception device, wherein the retransmission processor transmits the part of the transmission data as retransmission data by use of the radio resource, and
the resource allocation unit allocates the radio resource to both of the reception device and the different reception device in a case where the retransmission processor transmits the part of the transmission data as the retransmission data.

5. The radio communication device according to claim 4, wherein the size determination unit determines a difference between a size of the transmission data and the determined size of the retransmission data as a size of certain data to be transmitted to the different reception device.

6. The radio communication device according to claim 4, further comprising a priority setting unit configured to, in a case where there are a plurality of the different reception devices, set for each of the plurality of reception devices a priority with which the resource allocation unit allocates the radio resource, the priority set according to the receiving quality information received by the information receiver, wherein
the resource allocation unit allocates the radio resource to a reception device having the highest priority among the plurality of reception devices and to the reception device to which the retransmission data is transmitted, in a case where the retransmission processor transmits the part of the transmission data as the retransmission data.

7. The radio communication device according to claim 5, further comprising:
a modulation scheme determination unit configured to determine a first modulation scheme used for data transmission to the reception device and a second modulation scheme used for data transmission to the different reception device; and
a size adjustment unit configured to adjust the size of each of the retransmission data and the certain data determined by the size determination unit, the adjustment being made according to the first modulation scheme and the second modulation scheme determined by the modulation scheme determination unit.

8. The radio communication device according to claim 7, wherein:
the size adjustment unit reduces the size of the retransmission data and increases the size of the certain data if an amount of information per symbol defined in the first modulation scheme is smaller than an amount of information per symbol defined in the second modulation scheme; and
the size adjustment unit increases the size of the retransmission data and reduces the size of the certain data if the amount of information per symbol defined in the first modulation scheme is larger than the amount of information per symbol defined in the second modulation scheme.

9. The radio communication device according to claim 1, further comprising:
a modulation scheme determination unit configured to determine a modulation scheme to be used for data transmission to the reception device; and
a size determination unit configured to determine a size of the retransmission data to be transmitted by the retransmission processor in a case where the retransmission processor transmits the part of the transmission data as the retransmission data, the size being determined according to the modulation scheme determined by the modulation scheme determination unit.

10. The radio communication device according to claim 1, wherein:
in a case where the response judgment unit judges that the response message has not been received normally and where the transmission data is real-time data for which low latency is required, the retransmission processor transmits the entire transmission data as the retransmission data; and
in a case where the response judgment unit judges that the response message has not been received normally and where the transmission data is data other than the real-time data, the retransmission processor transmits the part of the transmission data as the retransmission data.

11. A radio communication method including the steps of:
transmitting encoded transmission data to a reception device;
receiving from the reception device a response message indicating whether or not the reception device has succeeded in decoding the transmission data; and
transmitting to the reception device retransmission data corresponding to the transmission data when the response message received in the receiving step indicates failure of the decoding of the transmission data,
the retransmission data being combined with the transmission data in the reception device,
the radio communication method comprising a step of judging whether or not the response message has been normally received from the reception device after the transmission of the transmission data, wherein
in the step of transmitting the retransmission data, a part of the transmission data is transmitted as the retransmission data if it is judged that the response message has not been normally received in the judging step.
